(19) United States
(12) Patent Application Publication
(10) Pub. No.: US 2014/0361028 A1
(43) Pub. Date: Dec. 11, 2014

(54) ACCESS PORT COVER SYSTEM

(71) Applicant: DANIEL J. GROOT, CLEARWATER, FL (US)

(72) Inventor: DANIEL J. GROOT, CLEARWATER, FL (US)

(21) Appl. No.: 14/301,449

(22) Filed: Jun. 11, 2014

Related U.S. Application Data
(60) Provisional application No. 61/833,483, filed on Jun. 11, 2013.

(51) Int. Cl. F16L 55/115

(52) U.S. Cl. CPC F16L 55/115
USPC 220/806

(57) ABSTRACT

A generally cylindrical base (104) has an upper cylindrical recess (106), a lower cylindrical recess (108) with a diameter less than the diameter of the base to form an annular bearing surface (110), and J-shaped locking notches (112). An elastomeric sealing member (122) is positioned within the upper recess in sealing contact with the bearing surface. A pin (144) extends through the sealing member with end ears (150) positionable in the J-shaped locking notches for locking and sealing.

### RELATED APPLICATION

The present application is based upon Provisional Application No. 61/833,483 filed Jun. 11, 2013 and is adapted for use in association with the invention of my earlier invention as disclosed and claimed in Application Number 05/31/2012 filed May 31, 2011, issued Feb. 18, 2014 as U.S. Pat. No. 8,651,303.

### BACKGROUND OF THE INVENTION

1. Field of the Invention

The present invention relates to an access port cover system and more particularly pertains to covering a cylindrical port and for abating water leakage in a safe, reliable, and convenient manner.

2. Description of the Prior Art

The use of access port cover systems of known designs and configurations is known in the prior art. More specifically, access port cover systems of known designs and configurations previously devised and utilized for the purpose of covering a port and abating water leakage are known to consist basically of familiar, expected, and obvious structural configurations, notwithstanding the myriad of designs encompassed by the crowded prior art which has been developed for the fulfillment of countless objectives and requirements.

While these devices fulfill their respective, particular objectives and requirements, they do not describe an access port cover system that allows covering a cylindrical port and for abating water leakage in a safe, reliable, and convenient manner.

In this respect, the access port cover system according to the present invention substantially departs from the conventional concepts and designs of the prior art, and in doing so provides an apparatus primarily developed for the purpose of covering a cylindrical port and for abating water leakage in a safe, reliable, and convenient manner.

Therefore, it can be appreciated that there exists a continuing need for a new and improved access port cover system which can be used for covering a cylindrical port and for abating water leakage in a safe, reliable, and convenient manner. In this regard, the present invention substantially fulfills this need.

### SUMMARY OF THE INVENTION

In view of the foregoing disadvantages inherent in the known types of access port cover systems of known designs and configurations now present in the prior art, the present invention provides an improved access port cover system. As such, the general purpose of the present invention, which will be described subsequently in greater detail, is to provide a new and improved access port cover system and method which has all the advantages of the prior art and none of the disadvantages.

To attain this, the present invention essentially comprises a generally cylindrical base having an upper cylindrical recess, a lower cylindrical recess with a diameter less than the diameter of the base to form an annular bearing surface, and J-shaped locking notches. An elastomeric sealing member is positioned within the upper recess in sealing contact with the bearing surface. A pin extends through the sealing member with end ears positionable in the J-shaped locking notches for locking and sealing.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved access port cover system which has all of the advantages of the prior art access port cover systems of known designs and configurations and none of the disadvantages.

It is another object of the present invention to provide a new and improved access port cover system which may be easily and efficiently manufactured and marketed.

It is a further object of the present invention to provide a new and improved access port cover system which is of durable and reliable constructions.

An even further object of the present invention is to provide a new and improved access port cover system which is susceptible of a low cost of manufacture with regard to both materials and labor, and which accordingly is then susceptible of low prices of sale to the consuming public, thereby making such access port cover system economically available to the buying public.

Lastly, another object of the present invention is to provide an access port cover system for covering a cylindrical port and for abating water leakage in a safe, reliable, and convenient manner.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an exploded perspective illustration of an access port cover system constructed in accordance with the principles of the present invention.

FIG. 2 is a plan view of the collar shown in FIG. 1.

FIGS. 3 and 4 are cross sectional views taken along lines 3-3 and 4-4 of FIG. 2.

FIG. 5 is a plan view of the plunger shown in FIG. 1.

FIG. 6 is a side elevational view taken along line 6-6 of FIG. 5

FIG. 7 is a side elevational view taken along line 7-7 of FIG. 6.

FIG. 8 is a plan view of the gasket shown in FIG. 1.

FIG. 9 is a cross sectional views taken along line 9-9 of FIG. 8.

FIG. 10 is a plan view of an access port cover system constructed in accordance with an alternate embodiment of the invention.

FIG. 11 is a cross sectional views taken along line 11-11 of FIG. 10.

FIGS. 12 and 13 are a front elevational view and a plan view of the connector arm shown in FIG. 14.

FIG. 14 is a side elevational view, partially exploded, of the access port cover system of the alternate embodiment of the invention.

FIGS. 15, 16, and 17 are front elevational views of the gasket support, the connecting arm, and the latch as shown in FIG. 5.

The same reference numerals refer to the same parts throughout the various Figures.

### DESCRIPTION OF THE PREFERRED EMBODIMENT

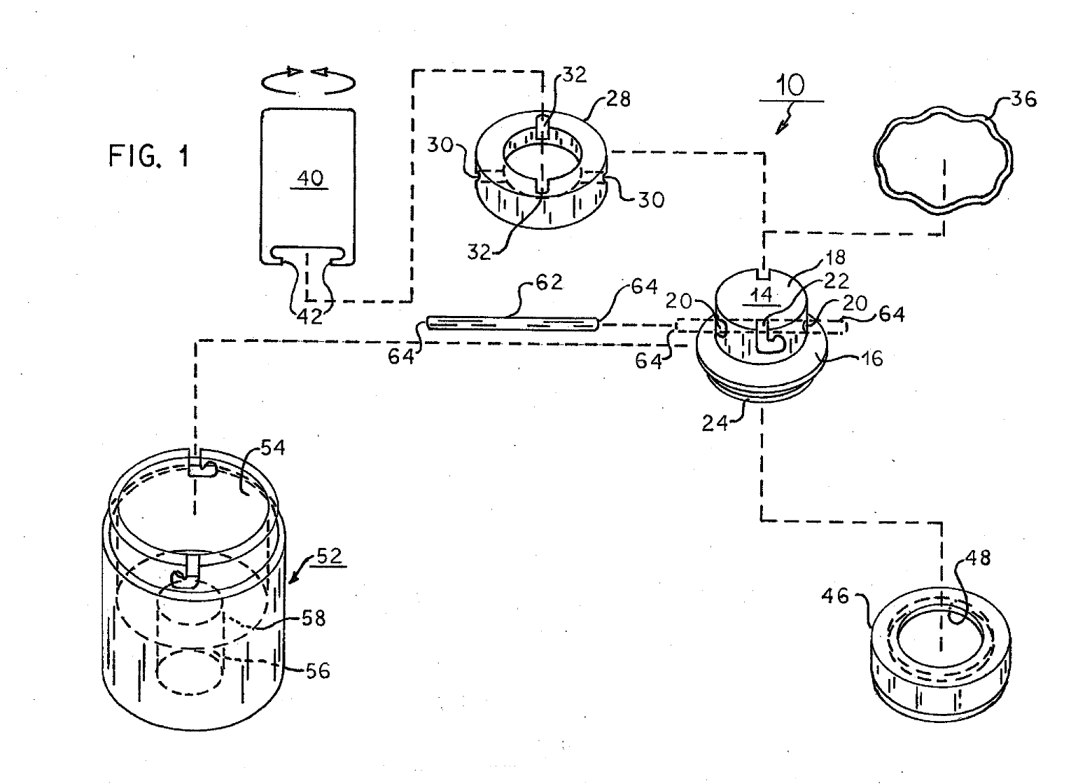

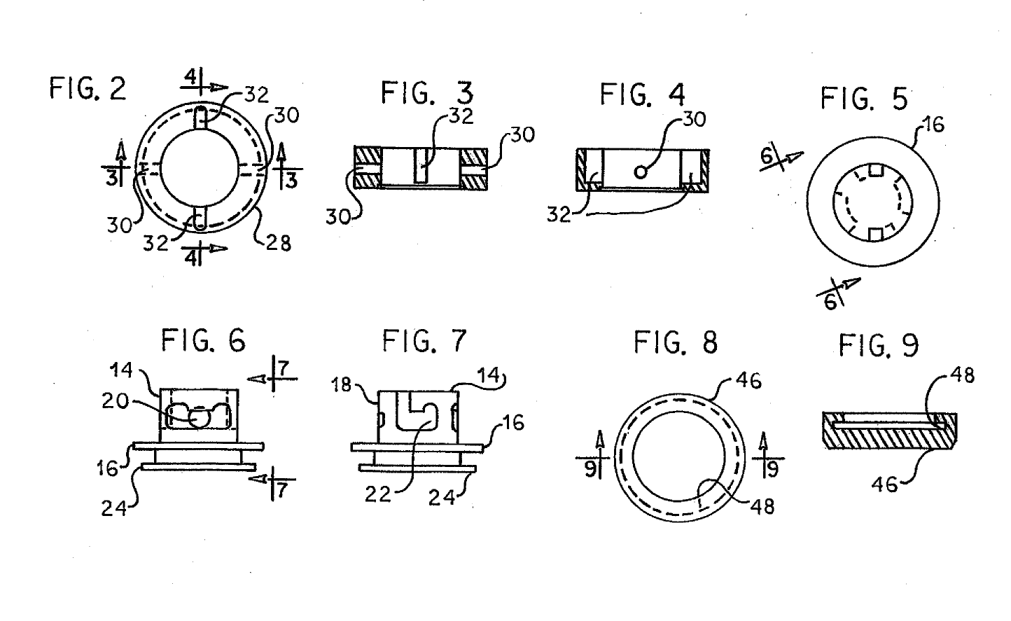

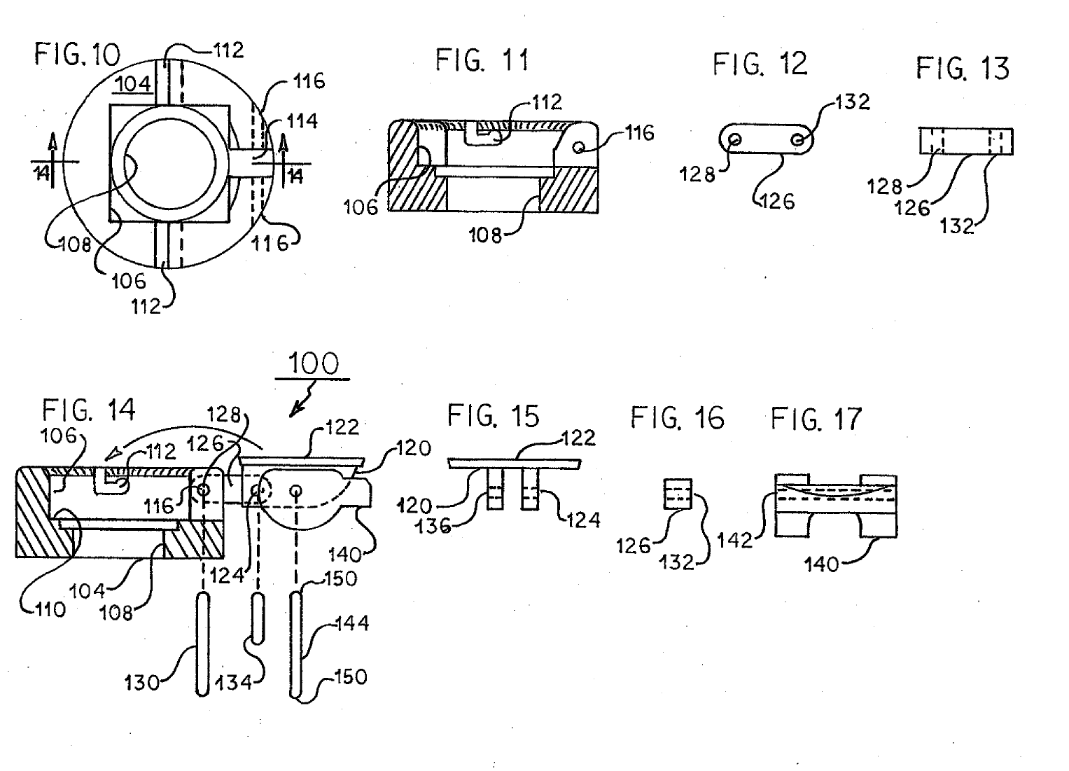

With reference now to the drawings, and in particular to FIG. 1 thereof, the preferred embodiment of the new and improved access port cover system embodying the principles and concepts of the present invention and generally designated by the reference numeral 10 will be described.

The present invention, the access port cover system 10 is comprised of a plurality of components. Such components in their broadest context include a base, an elastomeric sealing member, and a pin. Such components are individually configured and correlated with respect to each other so as to attain the desired objective.

The primary embodiment of the access port cover system 10 is for covering a cylindrical port and for abating water leakage. The covering and the abating are done in a safe, reliable, convenient and economical manner. First provided is a generally cylindrical plunger 14. The plunger has a centrally located annular projection 16. The plunger also has an upper cylindrical section 18 with a diametric bore 20 and peripherally located J-shaped locking notches 22. The plunger also has a lower annular collar 24.

Next provided in the primary embodiment is a generally ring-shaped collar 28. The collar has an interior opening positionable over the upper cylindrical section of the plunger. Diametric bores 30 are provided through the collar aligned with the diametric bore of the plunger. The collar has opposed notches 32 aligned with the locking notches of the plunger.

An undulating metallic wave washer 36 is next provided. The wave washer is positioned on the annular projection of the plunger and located between the plunger and the collar. In this manner, depressing the collar will resiliently deform the wave washer and decrease the axial distance between the collar and the plunger.

Next provided is a key 40. The key has in-turned teeth 42 positionable in the opposed notches of the collar and the J-shaped locking notches of the plunger. The key is adapted to be depressed and turned. In this manner, the in-turned teeth will be locked in position by the J-shaped locking notches.

A generally ring-shaped gasket 46 is next provided. The gasket is fabricated of an elastomeric material. The gasket has an interior opening positionable over the lower annular collar of the plunger with an annular recess 48 receiving and retaining the lower region of the plunger.

Next, a base 52 is provided. The base is in a generally cylindrical configuration. The base has an upper cylindrical recess 54 with a first diameter. The base also has a lower cylindrical recess 56 with a second diameter less than the first diameter to form an annular bearing surface 58. The gasket is positioned within the upper recess of the plunger with the gasket in sealing contact with the bearing surface of the plunger.

A pin 62 is next provided. The pin has a central extent located in the bore of the plunger and the bores of the collar. The pin has end ears 64 exterior of the collar and positionable in the J-shaped locking notches of the base when the pin is rotated with respect to the base to lock the gasket in sealing contact with the base to abate moisture flow through the system.

An alternate embodiment of the access port cover system 100 is also for covering a cylindrical port and for abating water leakage. The covering and the abating are done in a safe, reliable, convenient and economical manner. In this alternate embodiment, first provided is a base 104. The base has a generally cylindrical configuration with an upper cylindrical recess 106 with a first diameter. The base has a lower cylindrical recess 108 with a second diameter less than the first diameter to form an annular bearing surface 110. The upper cylindrical recess has opposed J-shaped locking notches 112, a radial slot 114, and interior bores 116.

Next provided in the alternate embodiment is a gasket member 120. The gasket member has a circular gasket surface 122 positionable in facing contact with the annular bearing surface of the base. Central bores 124 are formed in the gasket member parallel with and adjacent to the interior bores. A connecting arm 126 with an interior bore 128 is aligned with the interior bores of the base. An interior pin 130 extends through the interior bores of the base and the connecting arm. The connecting arm has an intermediate bore 132 aligned with the intermediate bores of the gasket member. An intermediate pin 134 extends through the intermediate bores of the gasket member. The gasket member has an exterior bore 136.

Further in this alternate embodiment, a latch 140 is provided. The latch has an exterior bore 142 aligned with the exterior bore of the gasket member. An exterior pin 144 extends through the exterior bores of the latch and the gasket member. The exterior pin has a central extent within the gasket member and latch with end ears 150 positionable in the J-shaped locking notches of the base for locking purposes.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An access port cover system for covering a cylindrical port and for abating water leakage, the covering and the abating being done in a safe, reliable, convenient and economical manner, the system comprising, in combination:
a base with in a generally cylindrical configuration with an upper cylindrical recess with a first diameter, the base having a lower cylindrical recess with a second diameter less than the first diameter to form an annular bearing surface. J-shaped locking notches in the base;
an elastomeric sealing member positioned within the upper recess in sealing contact with the bearing surface; and
a pin extending through the sealing member with end ears positionable in the J-shaped locking notches for locking and sealing.

2. The system as set forth in claim 1 wherein the pin is shifted laterally for locking and sealing.

3. The system as set forth in claim 1 wherein the pin is shifted rotated for locking and sealing.

4. An access port cover system (10) for covering a cylindrical port and for abating water leakage, the covering and the abating being done in a safe, reliable, convenient and economical manner, the system comprising, in combination:
a generally cylindrical plunger (14) with a centrally located annular projection (16), an upper cylindrical section (18) with a diametric bore (20) and peripherally located J-shaped locking notches (22), a lower annular collar (24);
a generally ring-shaped collar (28) having an interior opening positionable over the upper cylindrical section of the plunger, diametric bores (30) through the collar aligned with the diametric bore of the plunger, the collar having opposed notches (32) aligned with the locking notches of the plunger;
an undulating metallic wave washer (36) positioned on the annular projection of the plunger, and located between the plunger and the collar whereby depressing the collar will resiliently deform the wave washer and decrease the axial distance between the collar and the plunger;
a key (40) with in-turned teeth (42) positionable in the opposed notches of the collar and the J-shaped locking notches of the plunger, the key adapted to be depressed and turned whereby the in-turned teeth will be locked in position by the J-shaped locking notches;
a generally ring-shaped gasket (46) fabricated of an elastomeric material and having an interior opening positionable over the lower annular collar of the plunger with an annular recess (48) receiving and retaining the lower region of the plunger;
a base (52) in a generally cylindrical configuration with an upper cylindrical recess (54) with a first diameter, the base having a lower cylindrical recess (56) with a second diameter less than the first diameter to form an annular bearing surface (58), the gasket being positioned within the upper recess of the plunger with the gasket in sealing contact with the bearing surface of the plunger; and
a pin (62) having a central extent located in the bore of the plunger and the bores of the collar, the pin having end ears (64) exterior of the collar and positionable in the J-shaped locking notches of the base when the pin is rotated with respect to the base to lock the gasket in sealing contact with the base to abate moisture flow through the system.

5. An access port cover system (100) for covering a cylindrical port and for abating water leakage, the covering and the abating being done in a safe, reliable, convenient and economical manner, the system comprising, in combination:
a base (104) having a generally cylindrical configuration with an upper cylindrical recess (106) with a first diameter, the base having a lower cylindrical recess (108) with a second diameter less than the first diameter to form an annular bearing surface (110), the upper cylindrical recess having opposed J-shaped locking notches (112), a radial slot (114), and interior bores (116);
a gasket member (120) having a circular gasket surface (122) positionable in facing contact with the annular bearing surface of the base, central bores (124) formed in the gasket member parallel with and adjacent to the interior bores, a connecting arm (126) with an interior bore (128) aligned with the interior bores of the base and an interior pin (130) extending through the interior bores of the base and the connecting arm, the connecting arm having an intermediate bore (132) aligned with the intermediate bores of the gasket member and an intermediate pin (134) extending through the intermediate bores of the gasket member, the gasket member having an exterior bore (136);
a latch (140) with an exterior bore (142) aligned with the exterior bore of the gasket member with an exterior pin (144) extending through the exterior bores of the latch and the gasket member, the exterior pin having a central extent within the gasket member and latch with end ears (150) positionable in the J-shaped locking notches of the base for locking purposes.
